(19) United States
(12) Patent Application Publication
(10) Pub. No.: US 2002/0098732 A1
(43) Pub. Date: Jul. 25, 2002

(54) Connector device for an endoscope

(75) Inventor: Masami Shimizu, Hachioji-shi (JP)

Correspondence Address: Scully, Scott, Murphy & Presser, 400 Garden City Plaza, Garden City, NY, 11530-0299, US

(73) Assignee: OLYMPUS OPTICAL CO., LTD., TOKYO (JP)

(21) Appl. No.: 10/007,020

(22) Filed: Dec. 4, 2001

(30) Foreign Application Priority Data
Jan. 19, 2001 (JP) 2001-012027
Jan. 19, 2001 (JP) 2001-012028

(51) Int. Cl. H01R 13/627

(52) U.S. Cl. 439/352

(57) ABSTRACT

In a connector device for an endoscope, provided with a plug to be connected to a receptacle of a video processor in order to transmit information from an image-pickup element to the video processor, the plug includes a contact portion having a substantially flat contact surface on which contacts are formed, and a projection in any other region than the contact surface, the receptacle incorporating, on the video-processor side thereof, a locking device designed to engage the projection of the plug, to hold the plug when the plug is set in the receptacle, and an operating device for unlocking the locking device.

### CROSS-REFERENCE TO RELATED APPLICATIONS

This application is based upon and claims the benefit of priority from the prior Japanese Patent Applications No. 2001-012027, filed Jan. 19, 2001; and No. 2001-012028, filed Jan. 19, 2001, the entire contents of both of which are incorporated herein by reference.

### BACKGROUND OF THE INVENTION

1. Field of the Invention

The present invention relates to a connector device for an endoscope, capable of connecting a receptacle of a video processor with a plug that is attached to an endoscopic image-pickup unit having an image-pickup element for picking up endoscopic images or a plug that is attached to an electronic endoscope having an image-pickup element in its distal end portion, thereby transmitting information from the image-pickup element to the video processor.

2. Description of the Related Art

Proposed in Jpn. Pat. Appln. KOKAI Publication No. 6-251828 is a connector device for an endoscope that uses a square card-type plug having a substantially flat contact surface, a so-called card-edge plug. In the connector device of this type, the contact surface of the plug is a flat surface, from which extends a locking arm. On the other hand, the receptacle is provided with a locking mechanism that includes a projection in engagement with an engaging portion of the locking arm.

When the plug is attached to the receptacle in this connector device, the engaging portion of the locking arm engages the projection of the receptacle, whereupon a locked state is established. In canceling the locked state, the locking arm is depressed to release the locking arm from the projection of the receptacle.

Also proposed in Jpn. Pat. Appln. KOKAI Publication No. 6-251828 is a device in which the contact surface of a plug and a receptacle are provided with a recess for engagement and a locking arm, respectively, so that the plug can be locked by causing the projection of the locking arm to engage the recess of the plug as the plug is set in position. In canceling the locked state, the locking arm is pushed up to disengage its projection from the recess of the plug.

In either of the connector devices described above, the locking mechanism for locking the plug in the receptacle is constructed by utilizing a part of the contact surface of the plug, so that the corresponding region of the contact surface of the plug is subject to irregularities. It is hard, therefore, to clean, disinfect, or sterilize the contact surface of the plug. Besides, cleaning, disinfection, or sterilization is liable to cause water or disinfectant solution to collect in the irregular portions of the contact surface, so that it requires much time and labor to dry the contact surface fully.

If the connector device for an endoscope is used without fully drying the contact surface, electrolysis may possibly be caused between contacts that have differences in potential, thereby corroding the contacts. Further, there is a possibility of the contacts being electrically shorted to exert a bad influence upon the quality of endoscopic images.

In a connector device for an endoscope described in DE19754667A1, on the other hand, the distal end portion of a substrate that is located in a plug extends from the distal end of a plug housing and serves directly as a contact portion. In this integral structure having the substrate and the contact portion continuous with each other, the contact portion has some problems related to strength and repairability.

More specifically, the substrate usually has a thickness of about 1 to 2 mm, and a thickness of this degree is not good enough to secure a satisfactory strength for the contact portion. Possibly, the substrate may be thickened to increase its strength. Since the substrate cannot be partially thickened, according to this method, however, that part of the substrate which is situated in the plug is also thickened, which increases the size of the plug, inevitably. If the contact portion is broken, the whole substrate, including the part in the plug, must be replaced with a new one, owing to its poor repairability.

In a connector device for an endoscope proposed in Jpn. Pat. Publication No. 2986053, moreover, a printed board and a contact portion are formed separately from each other. This connector device is designed so that the contact portion is located in an opening of a connector case and an armature spring is provided around the contact portion. In the connector device with this construction, the contact portion is located in the opening of the connector case. Therefore, the contact portion is situated in the inner part of the connector case and surrounded by the armature spring. Thus, the design of the contact portion is complicated, and the contact portion is surrounded by irregular portions. In consequence, the contact surface of the plug cannot be easily cleaned, disinfected, or sterilized. Further, cleaning, disinfection, or sterilization causes water or chemicals to collect in the irregular portions, so that fully drying the contact surface takes much time and labor.

The following problem has also recently been created regarding. That is, a high-temperature, high-pressure steam sterilization (hereinafter referred to as autoclave sterilization) is frequently used in consideration of cost and effect upon the environment. A waterproof cap is easily disengaged as pressure changes during autoclave sterilization. Autoclave sterilization may or may not include a drying process in its final stage. In the case where a drying process is not included, treatment of an object to be sterilized is finished when the object is moistened by water. Thus, a connector device that uses a contact portion with a complicated configuration is not fit for autoclave sterilization, since drying the contact portion is difficult and takes a lot of time.

An object of the present invention is to provide a connector device for an endoscope, designed so that the contact surface of a plug can be cleaned and dried with ease and the plug itself can be securely locked when it is set in a receptacle.

Another object of the invention is to provide a connector device for an endoscope, which uses a small-sized, high-repairability plug having a high-strength contact portion.

### BRIEF SUMMARY OF THE INVENTION

In order to achieve the above objects, according to the present invention, there is provided a connector device for an endoscope provided with a plug to be connected to a receptacle of a video processor in order to transmit information from an image-pickup element to the video processor, the plug including a contact portion having a substantially flat contact surface on which contacts are formed and a projection in another region other than the contact surface, the receptacle incorporating, on the video-processor side thereof, a locking device adapted to engage the projection of the plug to hold the plug when the plug is set in the receptacle and an operating device for unlocking the locking device.

### BRIEF DESCRIPTION OF THE SEVERAL VIEWS OF THE DRAWING

FIG. 1 is a diagram illustrating an endoscopic apparatus according to a first embodiment of the present invention;

FIG. 2 is a perspective view of a plug of a connector device for an endoscope according to the first embodiment;

FIG. 3 is a perspective view showing a state immediately before the plug is set in a receptacle of the connector device of the first embodiment;

FIG. 4 is a perspective view showing the plug set in the receptacle of the connector device of the first embodiment;

FIG. 5 is a planar sectional view showing the way the plug is set in the receptacle of the connector device of the first embodiment;

FIG. 6 is a sectional view showing the way the plug is set in the receptacle of the connector device of the first embodiment;

FIG. 7 is a sectional view showing the plug set in the receptacle of the connector device of the first embodiment;

FIG. 8 is a perspective view of a flap of the receptacle of the connector device of the first embodiment;

FIG. 9 is a sectional view showing a way the plug is set in a receptacle of a connector device for an endoscope according to a second embodiment;

FIG. 10 is a profile showing the plug set in the receptacle of the connector device of the second embodiment;

FIG. 11 is a perspective view of the plug of the connector device of the second embodiment;

FIG. 12 is a profile showing a way the plug is set in a receptacle of a connector device for an endoscope according to a third embodiment;

FIG. 13 is a profile showing the plug just set in the receptacle of the connector device of the third embodiment;

FIG. 14 is a perspective view of the plug of the connector device of the third embodiment;

FIG. 15 is an exploded perspective view of a plug of a connector device for an endoscope according to a fourth embodiment;

FIG. 16 is a profile of the plug of the connector device of the fourth embodiment;

FIG. 17 is a perspective view of the back portion of the plug of the connector device of the fourth embodiment;

FIG. 18 is a profile of a ferrule portion of the plug of the connector device of the fourth embodiment;

FIG. 19 is a perspective view of a contact portion of the plug of the connector device of the fourth embodiment;

FIG. 20 is a sectional view of the contact portion of the plug of the connector device of the fourth embodiment;

FIG. 21 is a perspective view of a printed board guide groove of the plug of the connector device of the fourth embodiment;

FIG. 22 is a sectional view of a contact portion of a plug of a connector device for an endoscope according to a fifth embodiment;

FIG. 23 is a sectional view of a contact portion of a plug of a connector device for an endoscope according to a sixth embodiment;

FIG. 24 is a perspective view of a contact portion of a plug of a connector device for an endoscope according to a seventh embodiment;

FIG. 25 is a sectional view of the contact portion of the plug of the connector device of the seventh embodiment;

FIG. 26 is a perspective view of a contact portion of a plug of a connector device for an endoscope according to an eighth embodiment; and

FIG. 27 is a sectional view of the contact portion of the plug of the connector device of the eighth embodiment.

### DETAILED DESCRIPTION OF THE INVENTION

(First Embodiment)

A connector device for an endoscope according to a first embodiment of the present invention will now be described with reference to FIGS. 1 to 8.

FIG. 1 shows an endoscopic apparatus 1 according to the present embodiment, which comprises an endoscope 3 having an elongated insert section 2, an endoscopic image-pickup unit 4 removably attached to the endoscope 3, and a light source unit 5 for supplying illumination light to the endoscope 3. The endoscopic apparatus 1 further comprises a video processor 6 for signal processing for the image-pickup unit 4 and a monitor 7 for displaying a picture signal delivered from the video processor 6. An electronic endoscope may be designed so that an image-pickup element is provided on the distal end portion of the elongated insert section 2 instead of using the endoscope 3 and the endoscopic image-pickup unit 4.

The endoscope 3 includes the elongated insert section 2, a large-diameter grip section 8 continuous with the rear end of the insert section 2, an eyepiece section 9 formed on the rear end of the grip section 8, and a light guide base 10 on the lateral portion of the grip section 8. A light guide cable 11 is connected to the light guide base 10. A connector 12 is provided on the extreme end of the light guide cable 11. The connector 12 can be detachably connected to the light source unit 5. As the connector 12 is connected to the light source unit 5, white light from a lamp (not shown) in the light source unit 5 is applied to an incident end face of a light guide (not shown) in the endoscope 3 through the light guide cable 11 and the light guide base 10. The illumination light is transmitted to an illumination window (not shown) at the distal end portion of the insert section 2 through the light guide. The illumination light is emitted forward from the illumination window and applied to a subject to illuminate it.

The illuminated subject is imaged on the incident end of an optical relay system (not shown) of the endoscope 3 by means of an objective lens (not shown) on the distal end portion of the insert section 2. The resulting image is transmitted to the eyepiece section 9 by means of the relay optical system. The image can be observed macroscopically through an eyepiece (not shown) of the eyepiece section 9.

The endoscopic image-pickup unit 4 is removably attached to the eyepiece section 9. The image-pickup unit 4 has therein a solid-state image-pickup element such as a CCD 29. An endoscopic image picked up by means of the solid-state image-pickup element is transmitted to the video processor 6 through a cable 13 and a plug 14. The video processor 6 is provided with a receptacle 15 to which the plug 14 can be removably attached.

The plug 14 and the receptacle 15 constitute a connector device 16 for the endoscope. The connector device 16 connects the video processor 6 with the cable 13 for transmitting information from the solid-state image-pickup element to the processor 6.

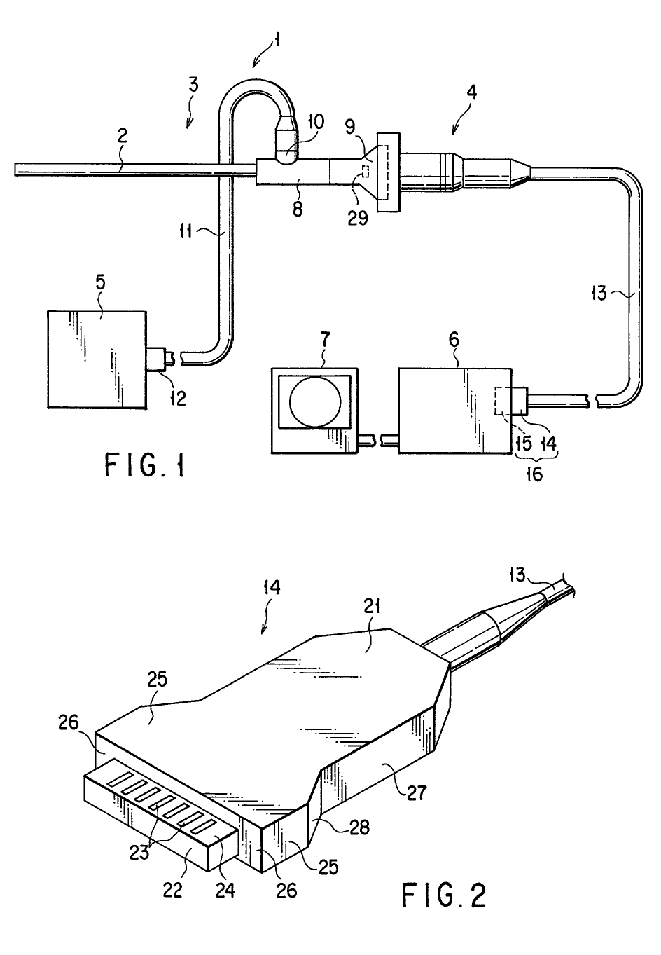

The configuration of the connector device 16 for the endoscope will now be described in detail with reference to FIGS. 2 to 8. As shown in FIG. 2, the plug 14 is provided with a plug body portion 21 for use as a body member. Basically, each outer surface of the plug body portion 21 is formed in a flat plane. The outer surfaces of the plug body portion 21 are free from any irregular portions such as grooves that are liable to collect liquid. If a cleaning fluid or other liquid is present on the outer surfaces of the plug body portion 21, therefore, the respective shapes of the outer surfaces allow the liquid to flow off easily, so that the liquid never remains on the body portion 21.

A contact portion 22 protrudes forward from the front end face of the plug body portion 21. The contact portion 22 is thinner than the plug body portion 21, and its upper and lower surfaces and left- and right-hand surfaces are all substantially flat surfaces that extend parallel to one another. A plurality of contact pins 23 are provided on the upper surface of the contact portion 22, and this upper surface forms a so-called contact surface 24 on which contacts are arranged. The whole contact surface 24, including the portions that carry the contact pins 23 thereon, is a substantially flat surface free from irregularities. If any liquid such as a cleaning fluid is present on the outer surfaces of the plug body portion 21, therefore, it can easily flow off and never remains on the outer surfaces.

A pair of projections 25, left and right, protrude sideways from the opposite side faces of the insert section 2, individually. In the present embodiment, the projections 25 protrude individually from the opposite sides of the front end portion of the plug body portion 21. As shown in FIG. 2, therefore, the front end portion of the plug body portion 21 is spread from side to side. The rear end portion of each projection 25 forms a slope portion 28, which smoothly connects the projection 25 and its corresponding side wall surface of the plug body portion 21. Despite the presence of the sloped projections 25, the outer surfaces of the plug body portion 21 have no depressions that could collect cleaning fluid or other liquids and is shaped so as to allow the liquid to flow off with ease. If any liquid adheres to the outer surfaces of the plug body portion 21, therefore, it can easily flow off without remaining on the outer surfaces. Although the projections 25 are provided individually on the opposite side faces of the plug body portion 21, one projection may be provided on one side face only.

The front end face of the plug body portion 21 forms a plug front face portion 26 as a so-called abutting end face that abuts against a plug engaging portion 61 (mentioned later) of the receptacle 15. The rear end portion of the plug body portion 21 forms a grip portion 27 that facilitates the operation of the plug 14. The cable 13 is led out from the central portion of the extreme rear end of the plug body portion 21.

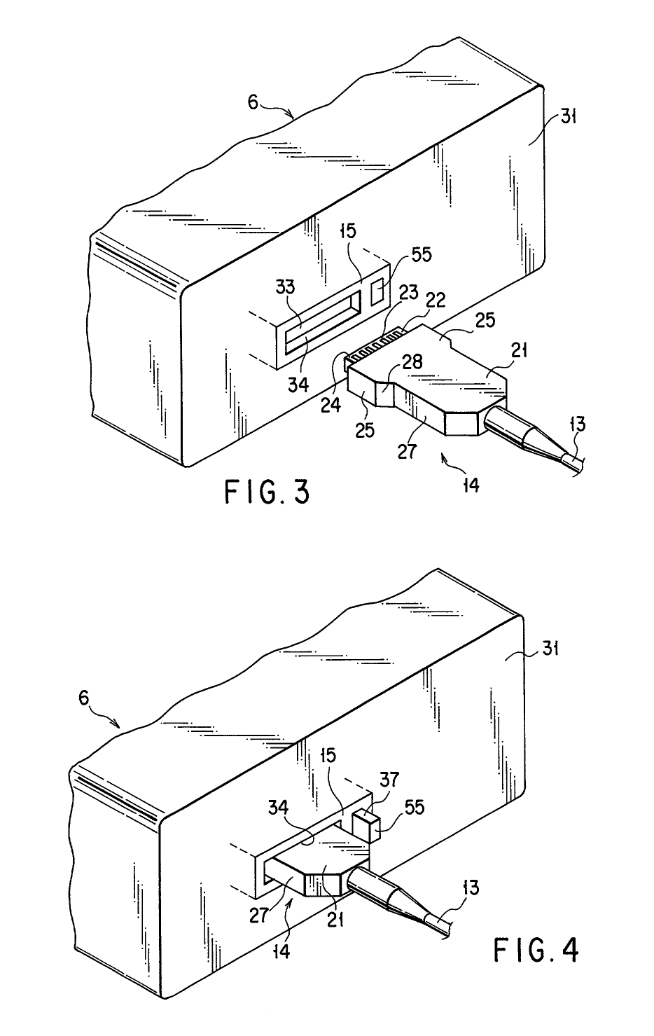

The plug 14 is inserted into the receptacle 15 of the video processor 6 in the manner shown in FIG. 3. Thereupon, plug 14 is connected to the receptacle 15, as shown in FIG. 4.

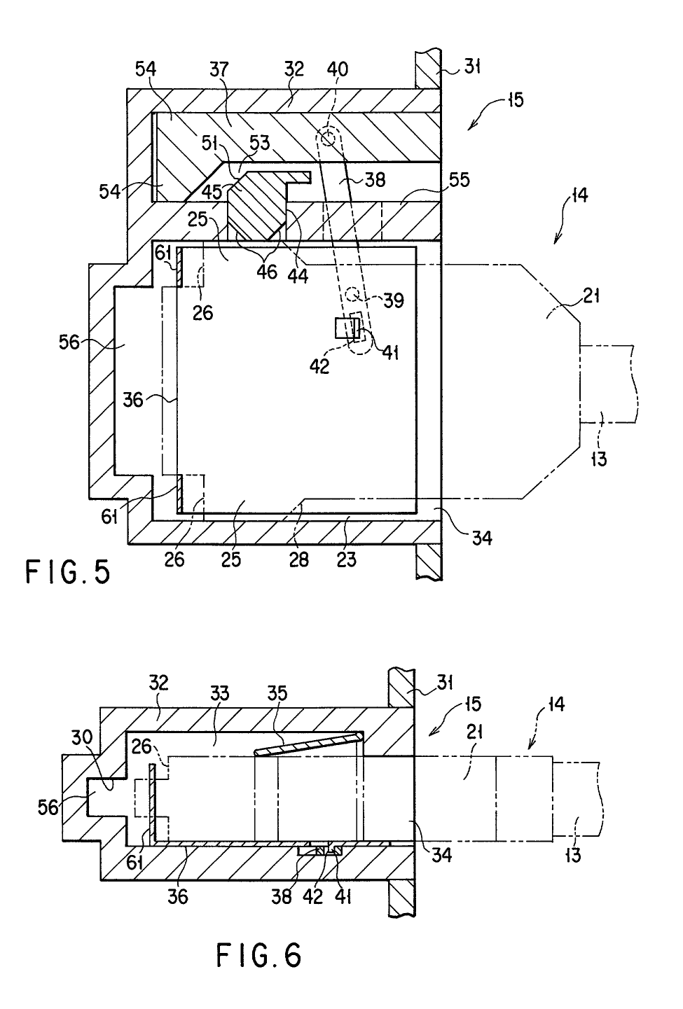

As shown in FIGS. 5 to 7, a receptacle body portion 32 of the receptacle 15 is incorporated in the video processor 6 in a manner such that it is fitted in a front panel 31 of the processor 6. An aperture 34 of a socket portion 33 for the insertion of the plug 14 opens outward from the front panel 31. The aperture 34 is closed by means of a flap 35 shown in FIG. 6 when it is not loaded with the plug 14.

Provided in the socket portion 33 of the receptacle body portion 32 is a base 36 that receives the inserted plug 14. The base 36 is movable in its longitudinal direction that is perpendicular to the outer surface of the front panel 31. Further, an operating member 37 for releasing a locking device (mentioned later) is located adjacent to a lateral part of the socket portion 33. The operating member 37 is also movable in its longitudinal direction that is perpendicular to the outer surface of the front panel 31. Thus, the base 36 and the operating member 37 can move parallel to each other.

The following is a description of the locking device. The base 36 and the operating member 37 are coupled to each other by means of a coupling member 38 in the form of an arm plate. The coupling member 38 is located under the base 36. An intermediate portion of the coupling member 38 is pivotally supported on the receptacle body portion 32 by means of a pivot 39. The coupling member 38 can rock within a horizontal plane under the base 36. One end of the coupling member 38 is pivotally mounted on the operating member 37. Further, a notch portion 42 is provided at the other end of the coupling member 38. A projection 41 that is formed by cutting and raising a part of the base 36 downward engages the notch portion 42. The base 36 and the operating member 37 are interlocked by means of the coupling member 38 and simultaneously move in opposite directions.

As shown in FIG. 5, the base 36 and the operating member 37 are divided by means of a wall portion 43. The wall portion 43 is provided with a cross hole 44 that penetrates the respective movement areas of the base 36 and the operating member 37. A stopper member 45 of the locking device is fitted in the cross hole 44. The stopper member 45 can slide so as to project or recede from the base 36 and the operating member 37. The stopper member 45 can also move crosswise or in the horizontal direction parallel to the plane of the front panel 31. Thus, the stopper member 45 is movable at right angles to the moving direction of the base 36 and the operating member 37.

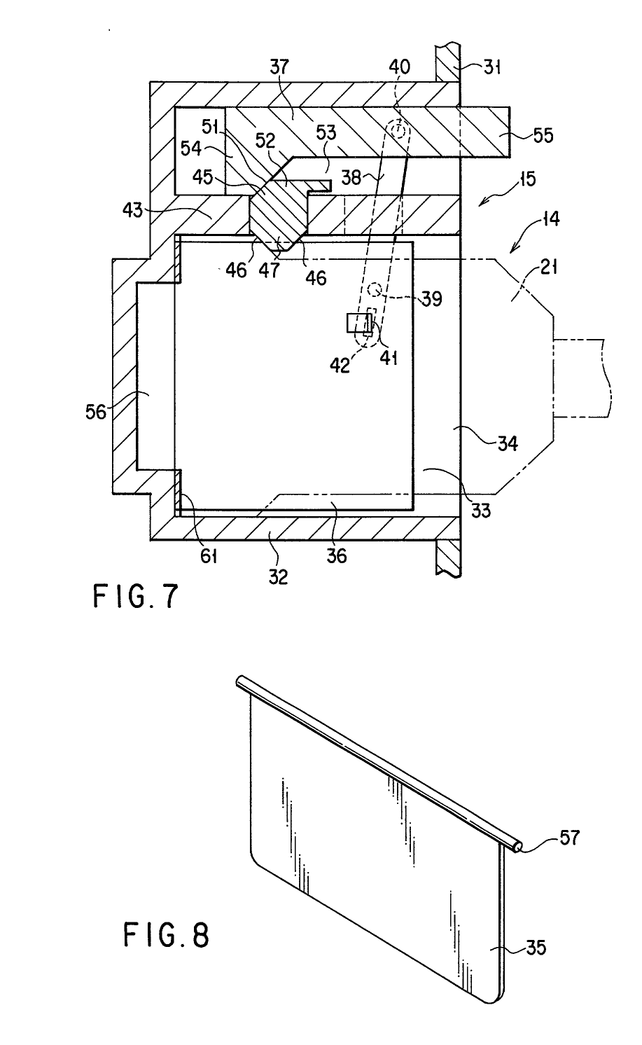

As shown in FIG. 7, that end portion of the stopper member 45 which faces the base 36 is provided with a first retaining portion 47 that includes front and rear slopes 46. On the other hand, that end portion of the stopper member 45 which faces the operating member 37 is formed having a second retaining portion 52 that has a slope 51 on the front end.

A hollow 53 to be penetrated by the second retaining portion 52 is cut in a lateral part of the operating member 37. The front end portion of the operating member 37 that is situated ahead of the hollow 53 forms a push portion 54 that serves to push the stopper member 45. Further, an operating portion 55 is provided on the outer end of the operating member 37. The operating portion 55 has a length such that it projects from the front panel 31 when the image-pickup unit 4 is set in the receptacle 15.

Contact pins 30 are located in an innermost end portion 56 of the socket portion 33. The contact pins are connected electrically to their corresponding contact pins 23 of the plug 14 when the plug 14 is set in the receptacle 15.

As shown in FIG. 8, the flap 35 that serves to open and close the aperture 34 is provided with a pivot 57 at one end thereof, and is swingably mounted in a manner such that the pivot 57 is pivotally supported on the receptacle body portion 32. When the plug 14 is not set in place, moreover, the flap 35 closes the aperture 34 by itself in a manner such that it is urged to rock in the direction to close the aperture 34 by means of, for example, a spring member (not shown).

The upright plug engaging portion 61 is formed on the front end of the base 36. When the plug 14 is set in the socket portion 33 of the receptacle 15, the plug engaging portion 61 is pressed by the plug front face portion 26 of the plug 14. In disengaging the plug 14, the plug front face portion 26 is pressed by means of the plug engaging portion 61.

When the plug 14 is set in the receptacle 15, the stopper member 45 engages the projection 25 of the plug body portion 21, thereby fixedly holding the plug 14. This locked state can be maintained by means of the push portion 54 of the operating member 37. These elements constitute a locking mechanism for fixedly holding the plug 14 that is set in the receptacle 15.

The following is a description of the operation for setting the plug 14 in the receptacle 15. After the plug 14 is opposed to the front face of the receptacle 15, as shown in FIG. 3, it is inserted into the socket portion 33 of the receptacle 15, as shown in FIG. 4. Thereupon, the flap 35 is swung open by means of the distal end of the plug 14 (see FIG. 6).

As the plug 14 is inserted into the socket portion 33, the plug front face portion 26 runs against the plug engaging portion 61 of the base 36, as shown in FIG. 5. If the plug 14 is further pushed in, it presses the plug engaging portion 61 of the base 36, whereupon the base 36 moves inward or away from the front panel 31. At this point of time, the projection 41 on the lower surface of the base 36 is in engagement with the notch portion 42 of the coupling member 38. Therefore, the coupling member 38 is operated by means of the base 36, and rocks around the pivot 39 of the receptacle body portion 32.

When the coupling member 38 rocks in this manner, the operating member 37 moves outward or forward from the front panel 31. The moment the operating member 37 projects from the front panel 31, as shown in FIG. 7, its stopper member push portion 54 pushes the stopper member 45, thereby causing it to move toward the plug 14. Thereupon, the stopper member 45 and the projection 41 of the plug 14 engage each other, thereby locking the plug 14 in the socket portion 33. In this state, the operating portion 55 of the operating member 37 projects from the surface of the front panel 31, as shown in FIG. 7.

The plug 14 is locked as its projection 25 and the stopper member 45 engage each other. Since the plug 14 is fixedly held in the receptacle 15, it cannot be drawn out as it is.

In removing the plug 14, on the other hand, the operating portion 55 of the operating member 37 is pushed in so that the operating member 37 moves backward with respect to the front panel 31. As this is done, the coupling member 38 rocks around the pivot 39 with respect to the operating member 37 so that the base 36 is moved to be drawn out. In this case, the stopper member push portion 54 of the operating member 37 moves backward with respect to the front panel 31 so that it is disengaged from the stopper member 45, as shown in FIG. 5. Thus, the stopper member 45 is allowed to move horizontally with respect to the front panel 31.

As the coupling member 38 rocks, it pushes the base 36 so that the base 36 is moved forward with respect to the front panel 31. As this is done, the plug engaging portion 61 of the base 36 pushes the plug front face portion 26, while the projection 25 of the plug body portion 21 pushes away the stopper member 45 and moves forward to unlock the plug 14. Accordingly, the plug 14, along with the base 36, moves forward (on the front face side) with respect to the front panel 31 so that a part of its grip portion 27 protrudes, as shown in FIGS. 5 and 6. Then, an operator can hold the grip portion 27 of the plug 14 and draw out the plug 14 from the receptacle 15.

In the present embodiment, the contact surface 24 of the plug 14 is substantially flat, so that its cleanability and hydro-extraction properties are satisfactory. Further, the plug body portion 21 has no depressions or the like that are liable to collect water or chemicals. Accordingly, there is no possibility of water or chemicals remaining in any other regions than the contact surface 24 and flowing onto the contact surface 24. When the plug 14 is set in the receptacle 15, moreover, it is fixed by means of the locking mechanism, so that it cannot be disengaged unexpectedly.

The plug engaging portion 61, operating member 37, stopper member 45, operating portion 55, and pivot 39 that are provided in the receptacle 15 may alternatively be attached to any members of the video processor 6.

(Second Embodiment)

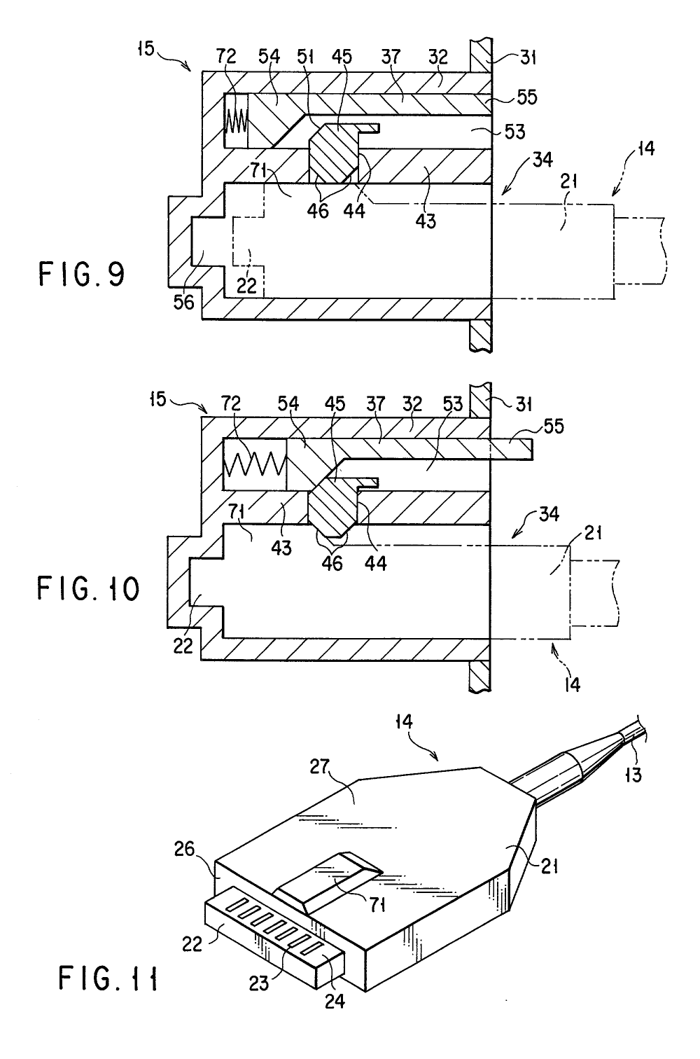

A connector device for an endoscope according to a second embodiment of the invention will now be described with reference to FIGS. 9 to 11. Like reference numerals are used to designate like portions of the first and second embodiments, and a detailed description of those portions is omitted.

A plug 14 of the present embodiment has a sloped projection 71 that is formed on the upper surface of its plug body portion 21. An elastic member 72 such as a coil spring is provided in a receptacle 15. One end of the elastic member 72 is fixed to a receptacle body portion 32. The other end of the elastic member 72 is fixed to the back of an operating member 37. The operating member 37 is urged toward the outside of the front face of a front panel 31.

A plug front face portion 26 and the projection 71 of the plug body portion 21, the elastic member 72, a stopper member 45, an operating member 37 including a stopper member push portion 54 and an operating portion 55, etc. constitute a locking mechanism for holding the plug 14 and the receptacle 15 in a set state.

According to the present invention, the operating member 37, stopper member 45, and elastic member 72 may be attached to any members that constitute the video processor 6, in place of the members of the receptacle 15. Although the projection 71 is provided on the upper surface of the plug body portion 21, it may alternatively be provided on a side face of the body portion 21, as in the case of the first embodiment. On the contrary, the projection 25 of the first embodiment may be provided on the upper surface of the plug body portion 21.

In releasing the locking device, the operating member 37 is pushed in. Thereupon, the stopper member 45 is freed so that the plug 14 can be inserted into the receptacle 15. As the plug 14 is inserted into the receptacle 15, the plug front face portion 26 pushes away the stopper member 45, as indicated by the two-dot chain line in FIG. 9, whereupon the operating member 37 moves inward to recede from front panel 31. As this is done, the elastic member 72 is compressed. If the plug 14 is further pushed in, loading is finished, as indicated by two-dot chain line in FIG. 10. Since the operating member 37 is urged to project from the front panel 31 by means of the force of pressure of the elastic member 72, it moves forward with respect to the front panel 31, so that its operating portion 55 projects from the outer surface of the front panel 31. As the operating member 37 moves in this manner, moreover, the stopper member push portion 54 of the stopper member 45 engages the projection 71 of the plug 14. As the stopper member 45 and the projection 71 engage in this manner, the plug 14 and the receptacle 15 are held in the set state. In this locked state, the plug 14 cannot be easily drawn out as it is.

In removing the plug 14, the outwardly projecting operating portion 55 of the operating member 37 is depressed to push in the operating member 37, resisting the restoring force of the elastic member 72. As this is done, the stopper member push portion 54 of the operating member 37 moves backward with respect to the front panel 31 and recedes from the stopper member 45, as shown in FIG. 9, so that the stopper member 45 is allowed to move. In this unlocked state, the plug 14 can be drawn out to be removed from the receptacle 15.

(Third Embodiment)

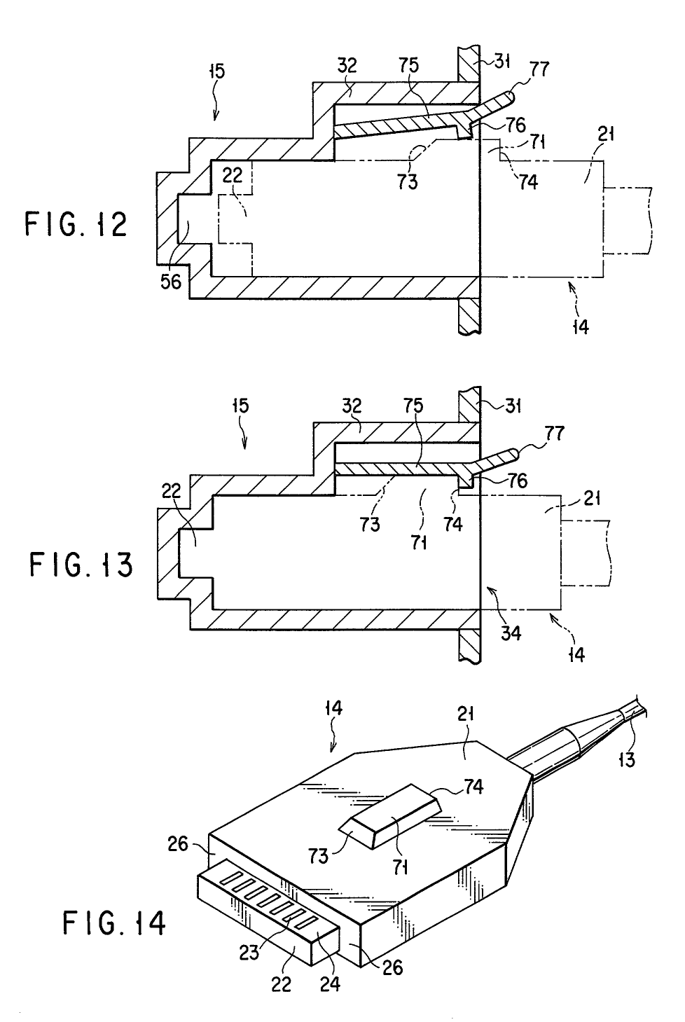

A connector device for an endoscope according to a third embodiment of the invention will now be described with reference to FIGS. 12 to 14. Like reference numerals are used to designate like portions of the first and third embodiments, and a description of those portions is omitted.

A plug 14 of the present embodiment has a projection 71 that is formed on the upper surface of its plug body portion 21. A slope 73 is formed on the leading end of the projection 71, and an upright retaining end 74 on the trailing end.

A receptacle 15 is provided with an elastic operating member 75, one end of which is fixed to a receptacle body portion 32. The operating member 75 includes an engaging portion 76 that can engage the projection 71 and an operating portion 77 that projects outward from a front panel 31. The operating member 75, operating portion 77, projection 71, and engaging portion 76 constitutes a locking mechanism for holding the plug 14 and the receptacle 15 in a set state.

The operating member 75 may be provided on a member of the video processor 6 in place of the receptacle 15. Although the projection 71 is provided on the upper surface of the plug body portion 21, moreover, it may alternatively be provided on a side face of the body portion 21, as in the case of the first embodiment.

The following is a description of operation for setting the plug 14 in the receptacle 15. If the plug 14 is inserted into the receptacle 15, its projection 71 pushes up the engaging portion 76 of the operating member 75, whereupon the operating member 75 bends. If the plug 14 is further pushed in, the engaging portion 76 of the operating member 75 drops onto the retaining end 74 of the projection 71. Thereupon, the operating member 75 is restored to its original shape such that the engaging portion 76 of the operating member 75 is caught by the retaining end 74 of the projection 71. As the projection 71 and the engaging portion 76 engage in this manner, the plug 14 and the receptacle 15 is held in the set state, so that the plug 14 cannot be drawn out as it is.

In removing the plug 14, on the other hand, the operating portion 77 is bent upward so that the projection 71 and the engaging portion 76 are disengaged from each other. If the plug 14 is drawn out with the operating member 75 kept deformed in this manner, it can be removed from the receptacle 15.

(Fourth Embodiment)

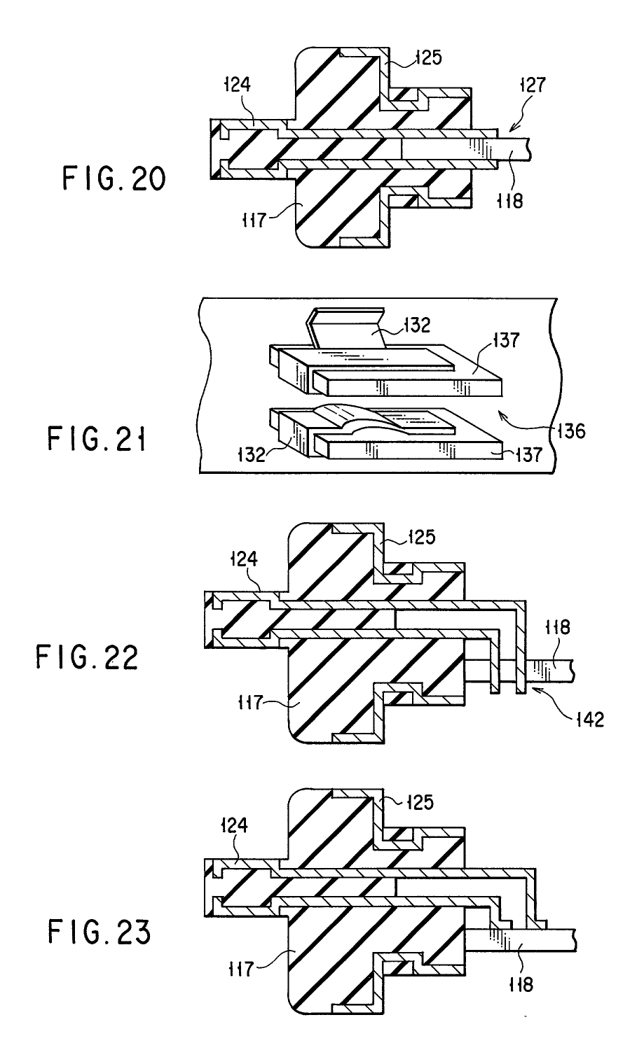

A connector device for an endoscope according to a fourth embodiment of the invention will now be described with reference to FIGS. 15 to 21. An endoscopic apparatus of the present embodiment is identical with the one according to the first embodiment. In the present embodiment, another example of the plug is used to connect a cable that extends from an endoscopic image-pickup unit 4 to a receptacle of a video processor.

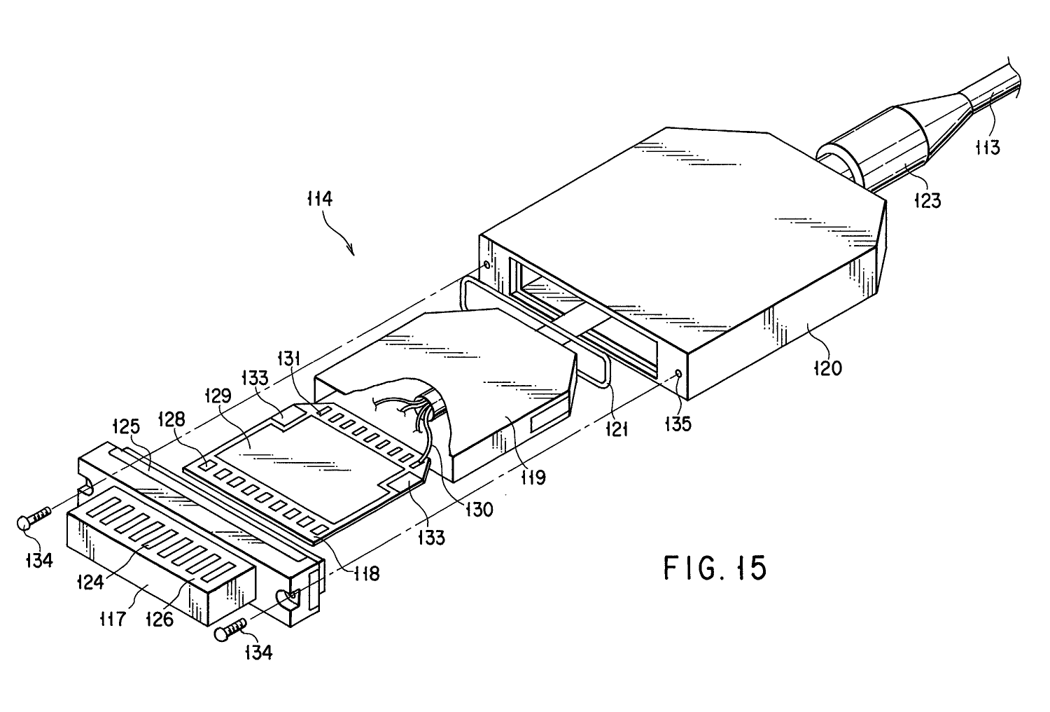

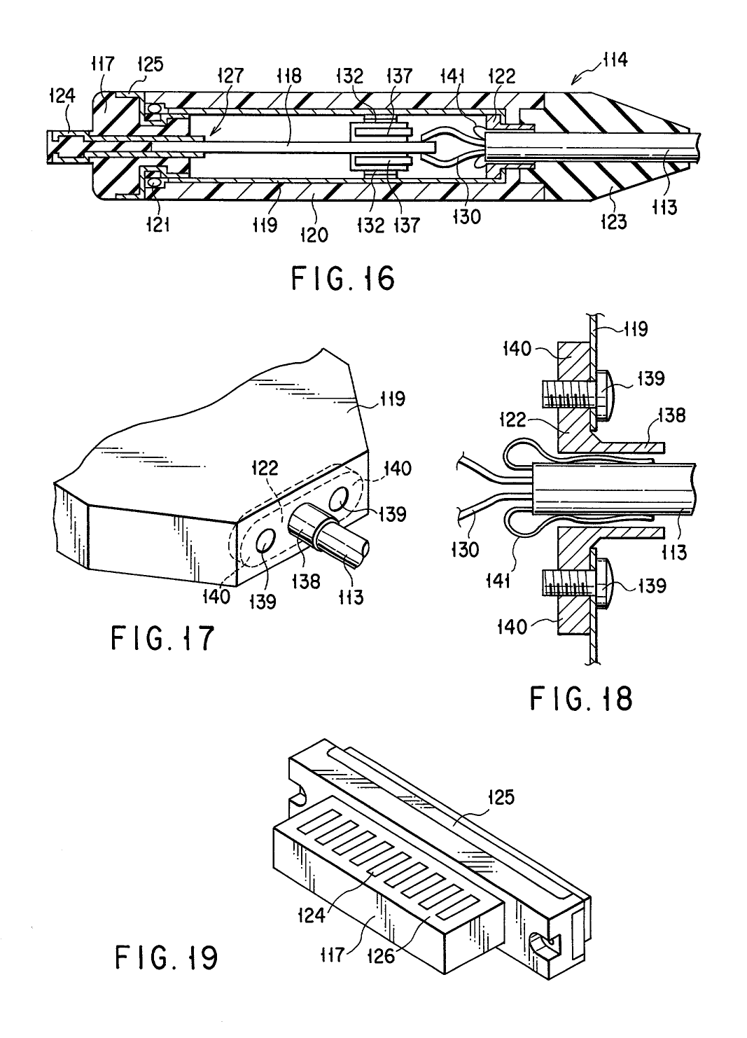

As shown in FIGS. 15 and 16, a plug 114 of the present embodiment comprises a contact portion 117 that is connected electrically to contact pins of the receptacle, a printed board 118 including a driver for driving a solid-state image-pickup element of the endoscopic image-pickup unit, etc., a shielding case 119 for electromagnetically shielding the printed board 118, and a plug body portion 120 in the form of a resin case that serves as a body portion of the plug 114. The plug 114 further comprises an O-ring 121 for waterproofness between the contact portion 117 and the plug body portion 120, a ferrule 122 for clamping a connecting end portion of a cable 113, and a plug rear end portion 123 that forms the rear end portion of the plug 114 and serves for waterproofness between the plug body portion 120 and the cable 113.

The contact portion 117 includes a body member of a resin such as polyphenyl sulfone that is resistant to an autoclave. The body member is molded integrally with a plurality of platelike contact pins 124 and a shielding plate 125 that practically surrounds the whole circumference of a part of the outer peripheral portion of the body. When the plug 114 is assembled, the shielding plate 125 is connected electrically to the shielding case 119. The contact portion 117 is thinner and narrower than the plug body portion 120. The upper and lower surfaces and left- and right-hand surfaces of the contact portion 117 are all substantially flat surfaces that extend parallel to one another.

The upper and/or lower surface of the contact portion 117 serves as a contact surface 126 that has the contact pins 124 thereon. Despite the presence of the contact pins 124, the contact surface 126 is a substantially flat surface without irregularities. The resin body of the contact portion 117, contact pins 124, and shielding plate 125 are molded in a watertight manner.

As shown in FIG. 16, moreover, an opening 127 into which the printed board 118 can be inserted is provided in the inner end portion of the contact portion 117. When the distal end portion of the printed board 118 is in the opening 127, first patterns 128 of the printed board 118 and the respective inner end extensions of the contact pins 124 are connected electrically to one another by soldering.

The printed board 118 is provided with a circuit portion 129, formed of a driver circuit for driving the solid-state image-pickup element of the endoscopic image-pickup unit, second patterns 131 (or through holes not shown) that are connected electrically to a plurality of conductors 130 of the cable 113 by soldering, and GND patterns 133 that are connected electrically to elastic armatures 132 (mentioned later).

The front wall of the plug body portion 120 is provided with tapped holes 135 into which first screws 134 are to be screwed individually. As shown in FIG. 21, each side face portion in the plug body portion 120 is provided with a guide groove 136 for guiding the printed board 118. Each guide groove 136 is provided with a pair of sidewalls 137 that constitute its upper and lower surfaces, individually. The elastic armatures 132, which are connected electrically to the GND patterns 133 of the printed board 118 and the shielding case 119, are integrally incorporated in their corresponding sidewalls 137 by press fitting, for example.

As the printed board 118 is inserted into the plug body portion 120, it is guided by means of the paired guide grooves 136. After the printed board 118 is inserted into the plug body portion 120, the contact portion 117 is fastened to the plug body portion 120 by means of the first screws 134. Thus, the printed board 118 and the plug body portion 120 are assembled integrally. The printed board 118 can be disengaged from the plug body portion 120 by removing the first screws 134. The printed board 118 is located in the plug body portion 120, and the members that constitute the contact portion 117 are attached to the plug body portion 120. However, any of these members can be detached as separate bodies.

As shown in FIG. 18, the ferrule 122 is provided with a contact-bonding portion 138 that is pressed against the inserted cable 113 to fix it and wing portions 140 that are fixed to the shielding case 119 by means of second screws 139. Shielded wires 141 of the cable 113 are doubled so as to be connected electrically to the contact-bonding portion 138 of the ferrule 122, and are in contact with the inner surface of the contact-bonding portion 138. Further, the ferrule 122 and the shielding case 119 are fastened by means of the second screws 139, and are connected electrically to each other by contact.

The following is a description of a method for assembling the plug 114. First, the O-ring 121 is attached to the contact portion 117, and the distal end portion of the printed board 118 is inserted into the opening 127 of the contact portion 117. In this state, the contact pins 124 of the plug 114 and the first patterns 128 of the printed board 118 are soldered to one another.

On the other hand, the cable 113 is passed in advance through the plug rear end portion 123, plug body portion 120, shielding case 119, and O-ring 121 in the order named, and the conductors 130 of the cable 113 are soldered individually to the second patterns 131.

Then, the shielded wires 141 of the cable 113 are doubled, and their turned portions are inserted into the contact-bonding portion 138 of the ferrule 122 to be subjected to contact bonding. Thereafter, the shielding case 119 is put on the printed board 118, and is fixed to the wing portions 140 of the ferrule 122 by means of the second screws 139. As this is done, the shielding case 119 and the shielding plate 125 of the contact portion 117 come into contact with each other, whereupon they are connected electrically. Further, the plug body portion 120 is put on the shielding case 119. Thereupon, the printed board 118 is inserted into the guide grooves 136 of the plug body portion 120, and the GND patterns 133 of the printed board 118 and the elastic armatures 132 press-fitted between the sidewalls 137 come into contact with one another, whereupon they are connected electrically. As this is done, the elastic armatures 132 also touch the shielding case 119 and are connected electrically to the case 119. The area between the contact portion 117 and the plug body portion 120 is kept waterproof by means of the O-ring 121.

Then, the contact portion 117 is fixed to the plug body portion 120 by means of the first screws 134. Finally, the area between the plug body portion 120 and the cable 113 is kept waterproof by means of the plug rear end portion 123.

If the contact portion 117 is broken, it should be replaced with a new one. This replacement is achieved by reversing the aforementioned procedural steps. The junction between the contact portion 117 and the printed board 118 is exposed, solder between the contact pins 124 and the first patterns 128 is removed, and the contact portion 117 is changed.

According to this arrangement, the contact portion 117 is formed by integrally molding the platelike contact pins 124, and the contact surface 126 is substantially flat. Therefore, the contact surface 126 is highly cleanable and cannot easily collect water or chemicals. Thus, cleaning, disinfection, and sterilization do not require the use of a waterproof cap. If water remains on the contact surface, therefore, it can be easily removed by being wiped up, so that the cleanability of the surface is satisfactory. Since the contact portion 117 and the printed board 118 are separate from each other, the contact portion 117 alone can be thickened to increase its strength, and the strength of the plug body portion can be assured without changing its size (or thinness). If the contact portion 117 is broken, moreover, it can be changed singly, so that the device is highly repairable.

(Fifth Embodiment)

A fifth embodiment of the invention will now be described with reference to FIG. 22. Like reference numerals are used to designate like portions of the fourth and fifth embodiments, and a description of those portions is omitted.

In the fourth embodiment, the opening 127 is formed in the back surface portion the contact portion 117, the distal end portion of the printed board 118 is fitted into the opening 127, and the contact pins 124 and the first patterns 128 are connected to one another by soldering. In to the present embodiment, however, the respective inner end portions of contact pins 124 are bent and inserted individually into through holes 142 in a printed board 118, and are soldered by dipping.

(Sixth Embodiment)

A sixth embodiment of the invention will now be described with reference to FIG. 23. Like reference numerals are used to designate like portions of the fourth and sixth embodiments, and a description of those portions is omitted.

In the fifth embodiment, the respective inner end portions of the contact pins 124 are bent, and the bent end portions are inserted individually into the through holes 142 in the printed board 118 and are soldered by dipping. In the present embodiment, however, the respective end portions of contact pins 124 are mounted on the surface of a printed board 118.

According to the present embodiment, which enjoys the same effects of the fourth embodiment, a contact portion 117 can be automatically mounted by means of a mounting machine, so that its cost can be lowered.

(Seventh Embodiment)

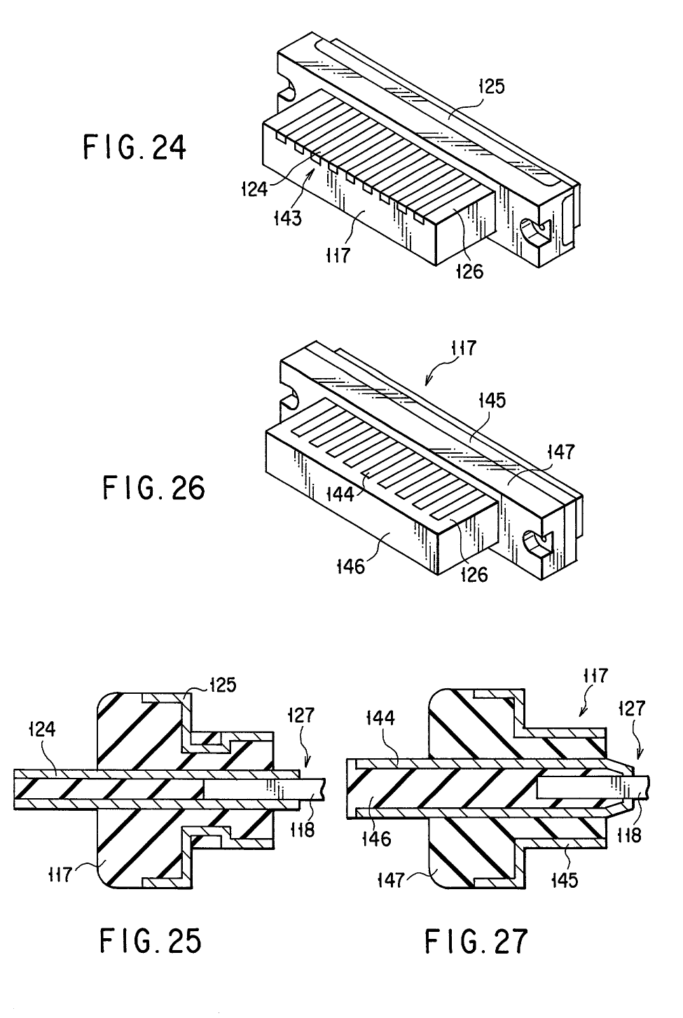

A seventh embodiment of the invention will now be described with reference to FIGS. 24 and 25. Like reference numerals are used to designate like portions of the fourth and seventh embodiments, and a description of those portions is omitted.

In the fourth embodiment, the contact pins 124 are molded integrally with the resin body portion of the contact portion 117. In the present embodiment, however, contact pins 124 are press-fitted in grooves 143 in the resin body portion instead of being molded integrally. The grooves 143 have substantially the same width and depth (or thickness) with the contact pins 124 so that a contact surface 126 is substantially flat.

(Eighth Embodiment)

An eighth embodiment of the invention will now be described with reference to FIGS. 26 and 27. Like reference numerals are used to designate like portions of the fourth and eighth embodiments, and a description of those portions is omitted.

In the fourth embodiment, the contact pins 124 are molded integrally with the resin body portion of the contact portion 117. In the present embodiment, however, contact patterns 144 are provided in place of the contact pins 124. Further, an armored GND pattern 145 is provided in place of the shielding plate 125. A contact portion 117 is formed of a post-formed portion 147 including the GND pattern 145 on a base 146 that carries the contact patterns 144 thereon.

In each of the embodiments described above, the connector device for an endoscope serves for the example of the endoscopic image-pickup unit with the image-pickup element that is attached to the eyepiece section of the endoscope and used to pick up endoscopic images. However, the present invention is also applicable to a connector device for an endoscope that is used to connect a receptacle with a plug of an electronic endoscope having an image-pickup element in the distal end portion of its endoscope, thereby transmitting information from the image-pickup element to a video processor.

What is claimed is:

1. A connector device for use in an endoscope, comprising:
a plug including a contact portion having a substantially flat contact surface, contacts provided in the flat contact surface, each of the contacts having a flat surface provided in flush with the flat contact surface, and at least one projection;
a receptacle which is provided in a video processor; and
a locking device and an operating device which are provided in the receptacle,
wherein when the projection is inserted in the receptacle, the locking device locks the projection so that the receptacle holds the plug and image-data are transferred to the vided processor through the contacts, and
wherein the operation device is configured to unlock the projection when the projection is withdrawn from the receptacle.

2. A connector device for an endoscope according to claim 1, wherein said plug includes a plug body member having a front end situated on the side for insertion into the receptacle, the contact portion protruding from the front end of the plug body member, and the projection being formed of a projecting part of the outer surface of the plug body member.

3. A connector device for an endoscope according to claim 1, wherein said plug includes a plug body member having flat surfaces such that a liquid, if any, present on the surfaces never stays thereon.

4. A connector device for an endoscope according to claim 1, wherein said plug has therein a printed circuit board separate from the contact portion.

5. A connector device for an endoscope according to claim 1, wherein said plug includes a plug body member having a front end situated on the side for insertion into the receptacle, the front end of the plug body member being fitted with component members of the contact portion, and the plug body member having therein a printed circuit board connected to the contact portion so that the printed board and the component members of the contact portion are detachable.
